(19) United States
(12) Patent Application Publication
(10) Pub. No.: US 2007/0033620 A1
(43) Pub. Date: Feb. 8, 2007

(54) Apparatus and method for displaying digital broadcasting program information

(75) Inventors: Sun-II Kim, Suwon-si (KR); Tae-Hyung Kim, Seoul (KR)

Correspondence Address: DILWORTH & BARRESE, LLP, 333 EARLE OVINGTON BLVD., UNIONDALE, NY, 11553, US

(73) Assignee: SAMSUNG ELECTRONICS CO., LTD., Suwon-si (KR)

(21) Appl. No.: 11/545,745

(22) Filed: Oct. 10, 2006

Related U.S. Application Data
(63) Continuation of application No. 11/110,308, filed on Apr. 20, 2005.

(30) Foreign Application Priority Data
Oct. 10, 2005 (KR) 95163-2005

(51) Int. Cl. H04N 5/445; G06F 3/00; G06F 13/00; H04N 7/173; H04N 7/16

(52) U.S. Cl. 725/62; 725/100; 725/43; 725/42

(57) ABSTRACT

An apparatus for receiving digital broadcasting and displaying program information regarding the digital broadcasting and a method thereof. The apparatus includes a digital broadcasting receiving unit for receiving broadcasting channel guide information, a memory for storing received broadcasting channel guide information, a control unit for creating program information based on the broadcasting channel guide information stored in the memory, and a display unit for displaying the program information created by the control unit on a background image in an idle mode.

### CROSS REFERENCE TO RELATED APPLICATIONS

This application is a Continuation Application of U.S. patent application Ser. No. 11/110,308, which was filed Apr. 20, 2005, and claims priority to an application entitled “Apparatus and Method for Displaying Digital Broadcasting Program Information” filed in the Korean Intellectual Property Office on Oct. 10, 2005 and assigned Serial No. 2005-95163 the contents of which are incorporated herein by reference.

### PRIORITY

This application claims priority to an application entitled “Apparatus and Method for Displaying the Information of Digital Broadcasting Channel” filed in the Korean Intellectual Property Office on Oct. 10, 2005 and assigned Serial No. 2005-95163, the contents of which are incorporated herein by reference.

### BACKGROUND OF THE INVENTION

1. Field of the Invention

The present invention relates to a terminal capable of receiving digital broadcasting and displaying program information regarding the digital broadcasting, and a method thereof; and more particularly, to an apparatus and a method for displaying program information on a background image and a method thereof.

2. Description of the Related Art

Electronic program guide (EPG) information is transmitted from broadcasting centers for a specific period of time and includes information regarding titles and simple keynotes of program broadcasting organized by time and channel. Terminals receive the EPG information and store it in an internal memory or file system, enabling a user to search for the EPG information and to select desired broadcasting.

However, it is very inconvenient for the user to individually search for an EPG menu of each time in order to recognize broadcasting programs and a channels for the programs. Therefore, if the user can recognize broadcasting programs and the channels for the programs without additional operations, the user may more satisfactorily and conveniently view a desired broadcasting program.

In addition, the user must search for the EPG information in a digital broadcasting mode. However, if the user searches for the EPG information in the digital broadcasting mode, a corresponding module (e.g., a broadcasting receiving module) may be driven, so that power consumption occurs. On the assumption that the user wants to only check a broadcasting program of a specific channel at current time and does not want to view the broadcasting program, if the user can check the broadcasting program without using the digital broadcasting mode, it is unnecessary to consume power.

### SUMMARY OF THE INVENTION

Accordingly, the present invention has been made to solve the above-mentioned problems occurring in the prior art, and an object of the present invention is to provide an apparatus and method that enables checking of program information of digital broadcasting without entering into a digital broadcasting mode in a terminal capable of receiving the digital broadcasting.

Another object of the present invention is to provide an apparatus and method that enables viewing of program information regarding digital broadcasting currently being served without requiring an individual search for the program information of a user.

To accomplish the above objects, there is provided an apparatus for displaying digital broadcasting program information in a terminal capable of receiving digital broadcasting, the apparatus including a digital broadcasting receiving unit for receiving broadcasting channel guide information, a memory for storing received broadcasting channel guide information, a control unit for creating program information based on the broadcasting channel guide information stored in the memory, and a display unit for displaying the program information created by the control unit on a background image.

According to another aspect of the present invention, there is provided a method for displaying digital broadcasting program information in a mobile communication terminal including a display unit and a digital broadcasting receiving unit, the method including the steps of storing received broadcasting channel guide information in a memory, creating program information based on the stored broadcasting channel guide information, and displaying the created program information on a background image of the display unit.

### BRIEF DESCRIPTION OF THE DRAWINGS

The above and other objects, features and advantages of the present invention will be more apparent from the following detailed description taken in conjunction with the accompanying drawings, in which:

FIG. 1 is a front planar view illustration of a mobile communication terminal capable of receiving DMB according to a the present invention;

FIGS. 2A and 2B are screen shots illustrating images having displayed DMB program information according to the present invention;

FIG. 3 is a block diagram illustrating a mobile communication terminal capable of receiving digital multimedia broadcasting according to the present invention;

FIG. 4 is a flow chart illustrating a method for displaying DMB program information in the mobile communication terminal of FIG. 3;

FIG. 5 is a block diagram illustrating a mobile communication terminal capable of receiving DMB according to a the present invention; FIG. 6 is a ladder diagram illustrating a method for displaying DMB program information by the mobile communication terminal of FIG. 5;

FIG. 6 is a flow chart illustrating a method for displaying DMB program information by the mobile communication terminal of FIG. 5;

FIG. 7 shows screen shots for illustrating a menu image for preference channel registration used for displaying DMB program information according to the present invention;

FIG. 8 shows screen shots for illustrating three background images which can be displayed in an idle mode before a program of a corresponding channel is displayed in the DMB mode through user selection according to the present invention;

FIG. 9 shows screen shots for illustrating images in which the DMB program information is displayed in the idle mode according to the present invention;

FIG. 10 is a view for illustrating left directional scrolling in the image in which the DMB program information is displayed in the idle mode according to the present invention;

FIG. 11 is a flowchart illustrating a method of displaying DMB program information on a background image in an idle mode according to the present invention; and

FIG. 12 is a flowchart illustrating a method of registering preference channels in order to display DMB program information on a background image in an idle mode according to the present invention.

### DETAILED DESCRIPTION OF THE PREFERRED EMBODIMENT

Hereinafter, a preferred embodiment of the present invention will be described in detail with reference to the accompanying drawings. Note that the same or similar components in drawings are designated by the same reference numerals as far as possible although they are shown in different drawings. Although many specific items, such as detailed channel numbers, detailed program names, etc., are shown in the following description, these are provided for the purpose of overall comprehension about the present invention. Therefore, it is generally known to the skilled in the art that the present invention can be practiced without being limited by the specific embodiments discussed herein. In the following description of the present invention, a detailed description of known functions and configurations incorporated herein will be omitted when it may make the subject matter of the present invention unclear.

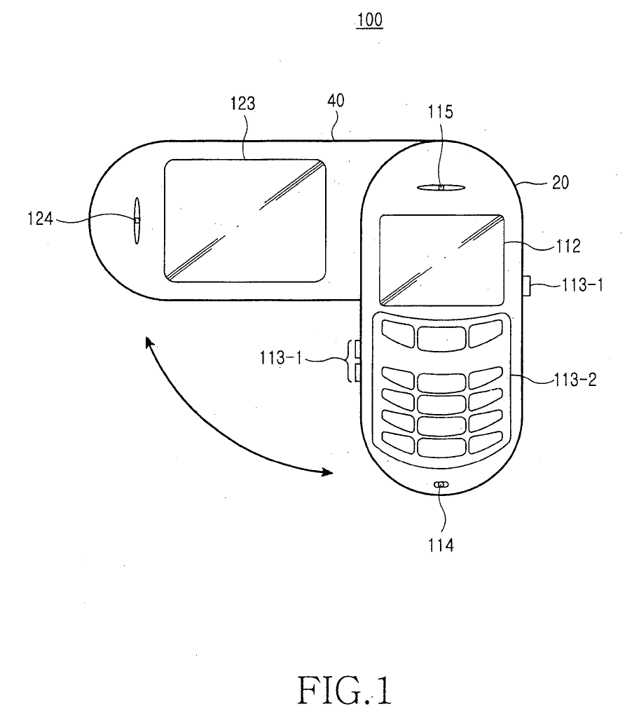

FIG. 1 is a front planar view illustration of a mobile terminal capable of receiving digital multimedia broadcasting (DMB) according to the present invention. The present invention may employ every terminal capable of receiving digital broadcasting, and it is assumed that the mobile communication terminal shown in FIG. 1 is a portable phone capable of receiving DMB.

A mobile communication terminal 100 according to a the present invention includes a main body 20 and a sub-body 40 coupled under the main body 20. The main body 20 includes a first display unit 112, a key input unit 113 having a side key 113-1 and a key pad 113-2, a microphone 114, and a first speaker 115, and is mainly used for performing functions relating to a portable telephone. The sub-body 40 includes a second display unit 123 and a second speaker 124 and is mainly used for performing multimedia functions. Herein, although a rotary-type sub-body 40 is illustrated, the sub-body 40 can include a folder or other type of body. A coupling relationship between the main body 20 and the sub-body 40 does not directly relate to the subject matter of the present invention.

As shown in FIG. 1, when the mobile communication terminal 100 is opened (that is, the main body 20 is not overlapped with the sub-body 40), DMB program information is displayed on a background image of the second display unit 123. If necessary, the first display unit 112 or both the display units 112 and 123 may display DMB program information on their background images. This is determined according to the selection of the user.

When the sub-body 40 is rotated and overlapped with the main body 20 (that is, the user can see only the first display unit 112), the DMB program information is displayed on a background image in the first display unit 112.

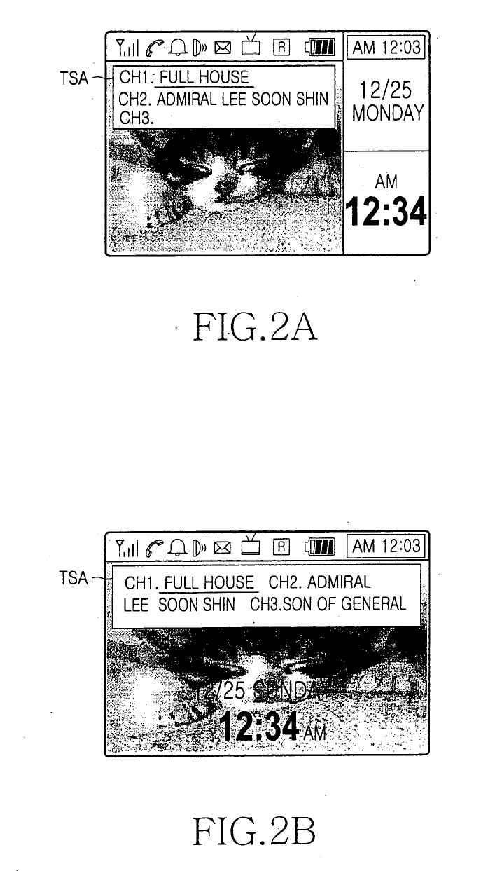

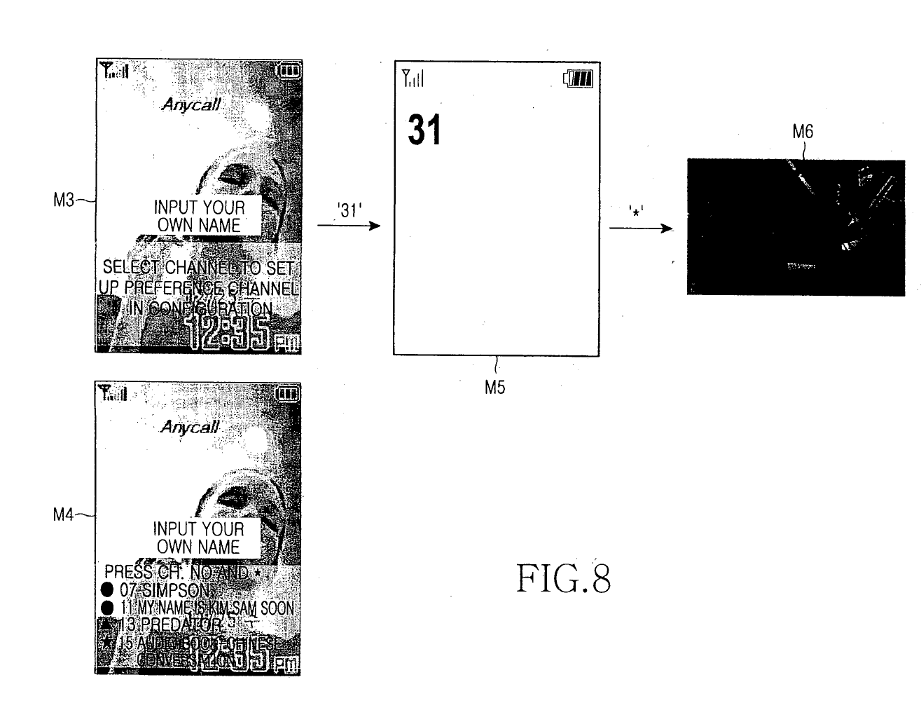

Herein, the DMB program information may be displayed in a predetermined area on a background image or as an entire image. In the following description, it is assumed that the DMB program information is displayed on a text slide area of a background image shown in FIGS. 2A and 2B or an image M4 shown in FIG. 8 is displayed on a partial area.

The mobile communication terminal 100 having the above described structure may perform a portable telephone function or a multimedia function according to operation by a user through the key input unit 113.

In addition, the user can view DMB through the second display unit 123 and confirm original functions of a portable terminal through the first display unit 112. The first display unit 112 and the second display unit 123 may be implemented using liquid crystal displays (LCDs).

FIGS. 2A and 2B are screen shots illustrating images on which DMB program information is displayed according to the present invention. Reference numeral “TSA” of FIGS. 2A and 2B represents the text slide areas of background images.

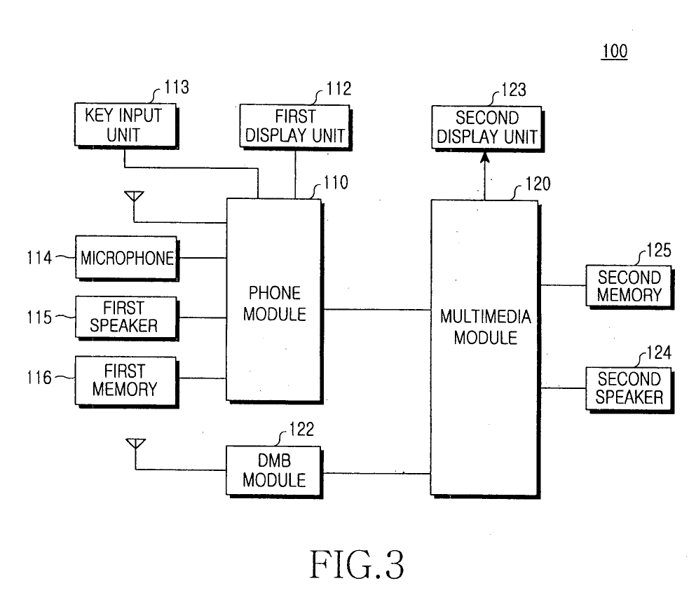

FIG. 3 is a block diagram illustrating a structure of a mobile communication terminal capable of receiving DMB according to the present invention.

As shown in FIG. 3, it is assumed that a first module (a phone module 110), a second module (a DMB module 122), and a third module (a multimedia module 120) are separated from each other. However, all or a portion of three modules may be included in one chip (e.g., a control unit).

The mobile communication terminal 100 according to the present invention may include a portable telephone capable of receiving DMB. The mobile communication terminal 100 may include the portable telephone function module (called a phone module) 110 for controlling a portable telephone function, the DMB module 122 for performing a broadcasting service receiving function, and the multimedia module 120 for controlling a multimedia function. The phone module 110 controls the first display unit 112, the key input unit 113, the microphone 114, the first speaker 115, and a first memory 116. The multimedia module 120 controls the second display unit 123, the second speaker 124, and a second memory 125.

The phone module 110 may be realized using radio frequency (RF) transmit/receive units and a modem chip (e.g., a QualComm MSM 5500 modem chip). The phone module 110 transmits/receives signals relating to communication and controls overall mobile communication terminal functions including portable telephone functions. The first display unit 112 displays information regarding the overall mobile communication terminal functions including the portable telephone functions and displays DMB program information on an entire background image or a portion of the background image (e.g., a text slide area).

The key input unit 113 receives data or a control command according to operation by a user. The microphone 114 receives audio signals. The first speaker 115 outputs audio signals (e.g., voice in communication) relating to the portable telephone functions. The first memory 116 stores information regarding the overall mobile communication terminal functions including the portable telephone functions.

The DMB module 122 is a module for receiving digital broadcasting and includes a unit for receiving a DMB RF signal through an antenna and a demodulator, which are not shown in the drawings because the subject matter according to the present invention is not concerned with such a detailed construction.

The multimedia module 120 decodes DMB data sent from the DMB module 122 into multimedia information (e.g., video, letters, and audio), and outputs the multimedia information to a user. The second display unit 123 displays an image signal output from the multimedia module 120. In addition, the second display unit 123 displays DMB program information on an entire background image or a portion of the background image (e.g., a text slide area). The second speaker 124 outputs an audio signal output from the multimedia module 120. The second memory 125 provides a DMB service and stores information (e.g., EPG information and a preference program information) regarding a DMB service.

The multimedia module 120 can determine a display unit for displaying DMB program information according to a folder state. In other words, if the folder is closed, the multimedia module 120 allows the first display unit 112 to display the DMB program information. If the folder is opened, the multimedia module 120 controls the second display unit 112 or both the display units 112 and 123 to display program information.

The first speaker 115, the second speaker 124, the first display unit 112, and the second display unit 123 may be constructed either as separate hardware or one integrated speaker and one integrated display unit. In addition, the multimedia module 120 may be realized using the H.264 CODEC multimedia processor.

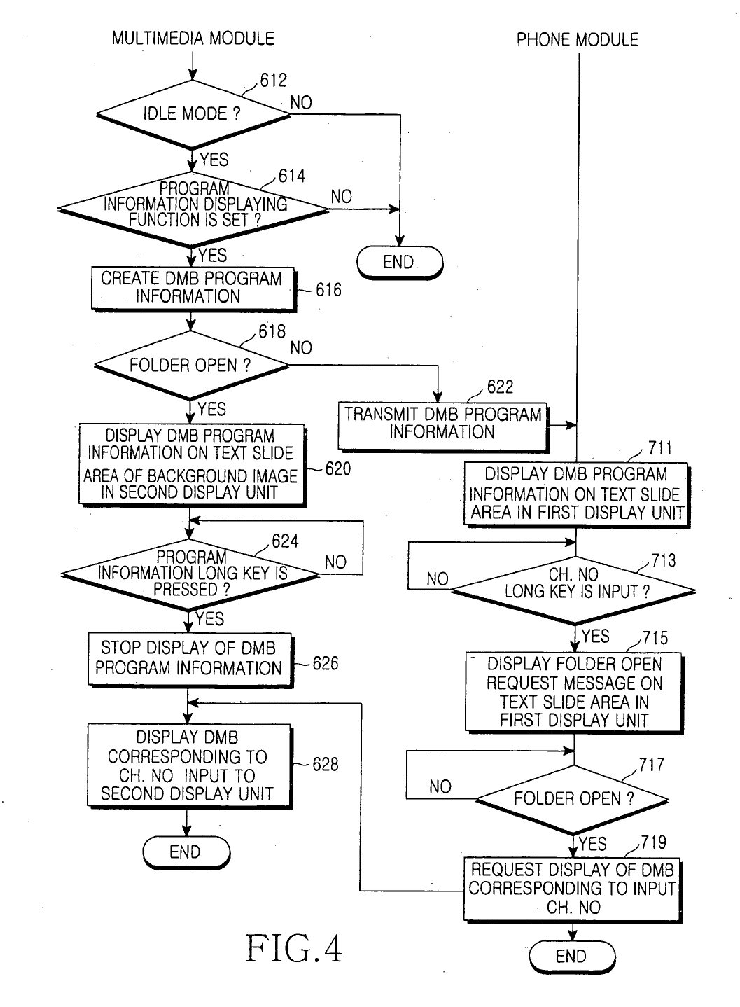

FIG. 4 is a flow chart illustrating a method for displaying DMB program information by the mobile communication terminal shown in FIG. 3.

If the multimedia module 120 detects an idle mode in step 612, the multimedia module 120 determines if a program information displaying function is set in step 614. If the program information displaying function is set, the multimedia module 120 creates DMB program information based on EPG information stored in the second memory 125 in step 616. Then, the multimedia module 120 determines if the mobile communication terminal folder is opened in step 618.

If the phone is not in an idle mode in step 612, or the broadcasting slide function is not set in step 614, the process ends.

If the folder is opened, the multimedia module 120 controls the second display unit 123 to display the DMB program information on a text slide area of a background image in step 620 as shown in FIGS. 2A and 2B. At this time, a user can select a channel based on the DMB program information. Herein, the user can use a long key in order to select the channel. The channel number long key is set to be valid in a program information displaying function. In other words, when the broadcasting slide function is set and a user presses a predetermined numeral key for a long time (i.e., a time greater than or equal to a predetermined value), the program of a corresponding DMB channel is displayed. But, the long key functions as a short dial in a general mode.

In step 624, the multimedia module 120 waits for a channel number long key press. Once pressed, the multimedia module 120 allows the second display unit 123 to stop displaying the DMB program information in step 626. In step 628, the DMB module is operated, receives a broadcasting program corresponding to the input channel number, and displays the broadcasting on the second display unit 123 through the multimedia module 120.

If the folder is not opened in step 618, the multimedia module 120 transmits DMB program information to the phone module 110 in step 622. After receiving the DMB program information, the phone module 110 controls the first display unit 112 to display the DMB program information on a text slide area of a background image in step 711. Thereafter, the phone module 110 waits for a channel number long key press in step 713. If the long key is pressed, the phone module 110 controls the first display unit 112 to display a folder open request message on the text slide area of the background image in step 715. If the user opens the folder based on the folder open request message, the phone module 110 detects that the folder open and requests the multimedia module 120 to display DMB corresponding to an input channel number in step 719. The multimedia module 120 having received the request controls the second display unit 123 to display DMB corresponding to the input channel number in step 628.

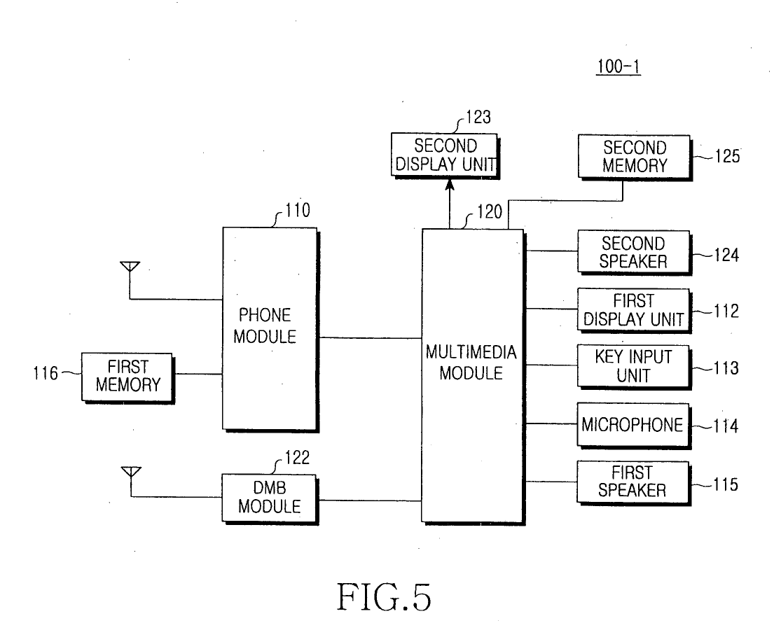

FIG. 5 is a block diagram illustrating a mobile communication terminal 100-1 capable of receiving DMB according to the present invention.

The mobile communication terminal 100-1 includes a personal data assistant (“PDA”) capable of receiving digital multimedia broadcasting. In a comparison of components in FIGS. 3 and 5, the components under the control of the phone module 110 in FIG. 3, except for the first memory 116, are controlled by the multimedia module 120 in FIG. 5 instead. This structure is based in part on the intrinsic structure of a PDA. Operation of each component shown in FIG. 5 is like that of its corresponding component in FIG. 3, except for the basic functions of the PDA. Accordingly, a detailed description about each component will be omitted and the same reference numerals will be employed.

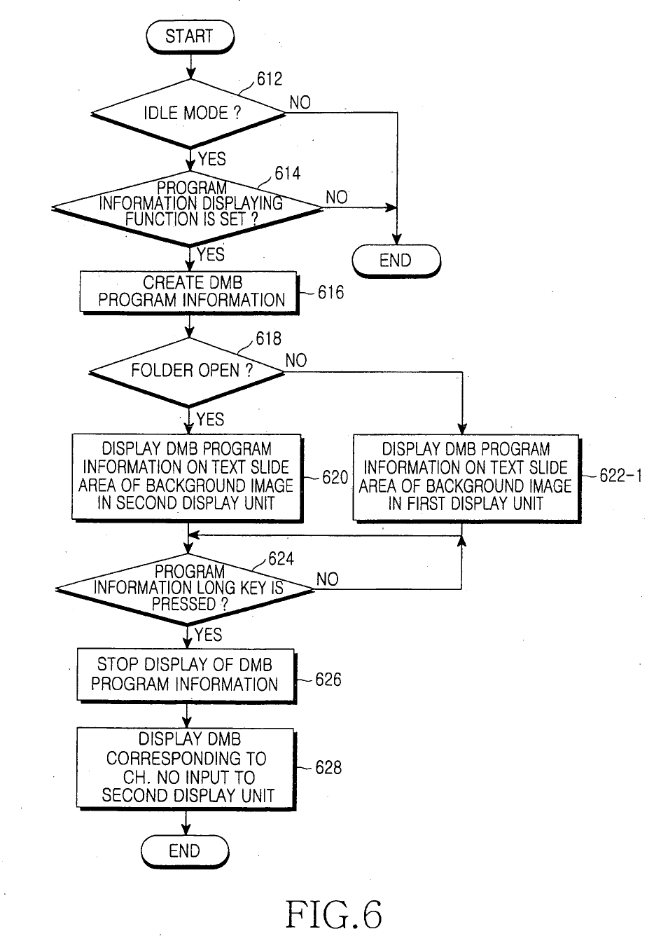

FIG. 6 is a flow chart illustrating a method for displaying DMB program information by the mobile communication terminal 100-1 shown in FIG. 5 according to the present invention.

If the multimedia module 120 detects an idle mode in step 612, the multimedia module 120 determines if a program information displaying function is set in step 614. If the program information displaying function is set, the multimedia module 120 creates DMB program information based on EPG information stored in the second memory 125 in step 616. The DMB program information may be set in such a manner that the DMB program information satisfies a predetermined condition.

If, however, the terminal is not in an idle mode in step 612, or the broadcasting slide function is not set in step 614, the process ends.

Herein, the predetermined criterion may be set by a user or based on time or channels. In further detail, the DMB program information may be made based on EPG information regarding broadcasting channels in overall time or current time. The multimedia module 120 determines if a folder of the mobile communication system 100-1 is opened in step 618.

If the folder of the mobile communication system 100-1 is opened, the multimedia module 120 controls the second display unit 123 to display DMB program information on a text slide area TSA of a background image in step 620. If the folder is not opened, the multimedia module 120 controls the first display unit 112 to display DMB program information on a text slide area TSA of a background image in step 622-1 as shown in FIGS. 2A and 2B. A user can select a channel based on the DMB program information. Herein, the user can use a long key in order to select the channel.

The multimedia module 120 waits for the long key in step 624. If the multimedia module 120 detects that the long key is pressed, the multimedia module 120 stops the display of the DMB program information in step 626. In step 628, the DMB module 122 is operated, receives a broadcasting program corresponding to the input channel number, and displays the broadcasting program on the second display unit 123 through the multimedia module 120.

Step 626 may be performed or not as needed. For example, when the folder is not opened in step 618, it is unnecessary to stop displaying DMB program information because the DMB program information is displayed on the first display unit 112. Although not shown, when the folder is opened in step 618, two display units 112 and 123 may be realized in such a manner that both the units 112 and 123 may display DMB program information. In this case, it is unnecessary to stop the display of DMB program information by the first display unit 112.

The long key for the channel number is valid for a program information displaying function. In other words, when a predetermined numeral key is pressed for a long time in the program information displaying function, the program of a corresponding DMB channel is displayed.

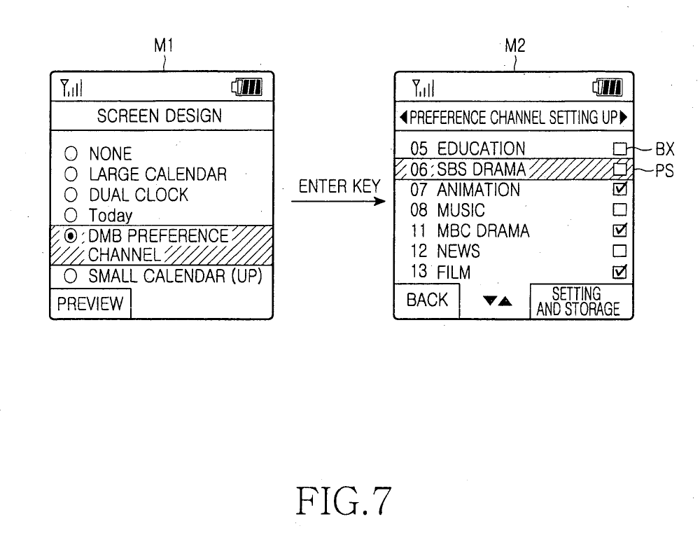

FIG. 7 shows screen shots for illustrating a menu image for preference channel registration used for displaying DMB program information according to the present invention.

Reference numeral M1 represents an initial menu image in an idle mode. If the user selects an item of a “DMB preference channel” among items displayed on the initial menu image M1 and presses an “Enter” key, a “preference channel setting up” sub-menu image shown through reference numeral M2 is displayed. The user can then select desired items among items displayed on the sub-menu image M2. Each item includes a channel number and a channel name. For example, “05” of an item “05 Education” represents a channel number, and “Education” of the “05 Education” represents a channel name. Although a shown example displays seven items on one screen, other items can be displayed through upward and downward scrolling using directional keys such as “▴”, “▾”, “ [symbol] ” and “ [symbol] ” keys.

The user brings desired items into focus PS and then selects the desired items using check boxes BX (these check boxes may be realized in such a manner that the check boxes are marked by pressing a specific key or selects them using a touch-screen input). When the user selects all desired items and then presses the “Enter” key, the selected items are registered in a memory (e.g., the second memory 125) as preference channels.

FIG. 8 shows screen shots for illustrating three background images which can be displayed in the idle mode before a program of a corresponding channel is displayed in the DMB mode through user selection according to the present invention.

Reference numeral M3 shows an image display state in the idle mode when there is no registered preference channel even though the display of the DMB preference channel is set up.

Reference numeral M4 shows an image display state in the idle mode when the display of the DMB preference channel is set up, and there are registered preference channels. The reference numeral M4 shows that four lines may be displayed at the same time, and one piece of program information may be displayed in one line. One piece of program information includes a channel icon (e.g., a video channel icon, an audio channel icon, and a premium channel icon), a channel number, and a program name. “• 07 Simpson” denotes the channel icon “•” (herein, “•” may be represents a video channel), the channel number “07”, and the program name “Simpson”, respectively.

Reference numeral M5 shows a case in which the user inputs “31” when one of two background images M3 and M4 is displayed. Thereafter, if the user presses a specific key (e.g., “*”), the input numeral or numerals (i.e., in the present example) is/are recognized as the channel number so that switching to the DMB mode starts.

Reference numeral M6 shows an image state in which the switching to the DMB mode is achieved, and a DMB program corresponding to the channel number “31” is displayed on the screen.

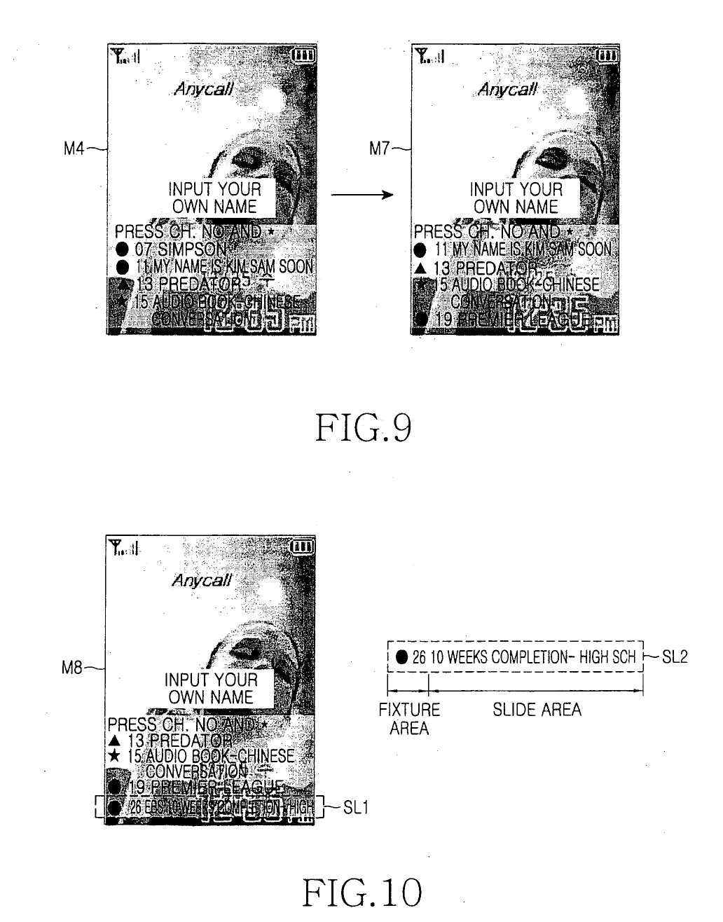

FIG. 9 is a view for explaining the upward scrolling and the downward scrolling in the image in which the DMB program information is displayed in the idle mode according to the present invention.

The M4 shows an image display state in the idle mode when the display of the DMB preference channel is set up, and there are registered preference channels. The M4 shows the image display state on the assumption that four pieces of program information can be displayed on one image. In a case in which the user has registered seven preference channels in advance, even though four pieces of program information are displayed on one image, the remaining three pieces of program information are displayed by performing the upward/downward scrolling.

Reference numeral M7 shows an image display state in which the upward scrolling of one line (one item) is achieved in the image display state of the M4. The image M7 shows that program information “• 07 Simpson” displayed on the image M4 is disappeared, and “• 19 premier league” is displayed.

The scrolling based on a unit of a line may be periodically performed. For example, through the scrolling, the image M4 may be maintained for 15 seconds and then changed into the image M7. An icon, arrow, or other element may be displayed to indicate that the user may scroll to review more information

FIG. 10 is a view for explaining left directional scrolling in the image in which the DMB program information is displayed in the idle mode according to the present invention.

Reference numeral M8 shows an image display state in the idle mode when the display of the DMB preference channel is set up, and there are selected preference channels. When one piece of program information is displayed in one line while displaying four pieces of program information as shown in FIG. 10, certain program information may not be displayed in one line at a time because contents of the program information may require more than one line to display. In this case, the entire contents of the program information may be displayed by performing scrolling in left and right directions. For example, on the assumption that the entire content of “• 26 EBS 10 weeks completion-high” is “• 26 EBS 10 weeks completion-high school 3^{rd} grades mathematics for the academic aptitude test”, the user may know the entire contents only when the scrolling is periodically performed in the left and right directions. A channel icon and a channel number of the program information do not undergo the scrolling because they are displayed on a fixture area, and only a program name undergoes the scrolling because it is displayed on a scroll area. Reference numeral SL2 shows a state in which a portion of an area SL1 is scrolled by one word in the left direction. In “26 EBS 10 weeks completion-high” displayed on the area SL 1 of the image M8, “EBS” in a beginning part of the scroll area is no longer displayed, and at least part of the next word, e.g., “sch” of “school” depending upon space, is displayed. Herein, the channel icon “•” and the channel number “26” in the fixture area do not undergo the scrolling.

The left/right scrolling may be realized in such a manner that the left/right scrolling can be performed with respect to all pieces of program information at the same time, or one piece of program information sequentially. Moreover, the scrolling may be automatically performed if certain program information is highlighted by, for example, scrolling.

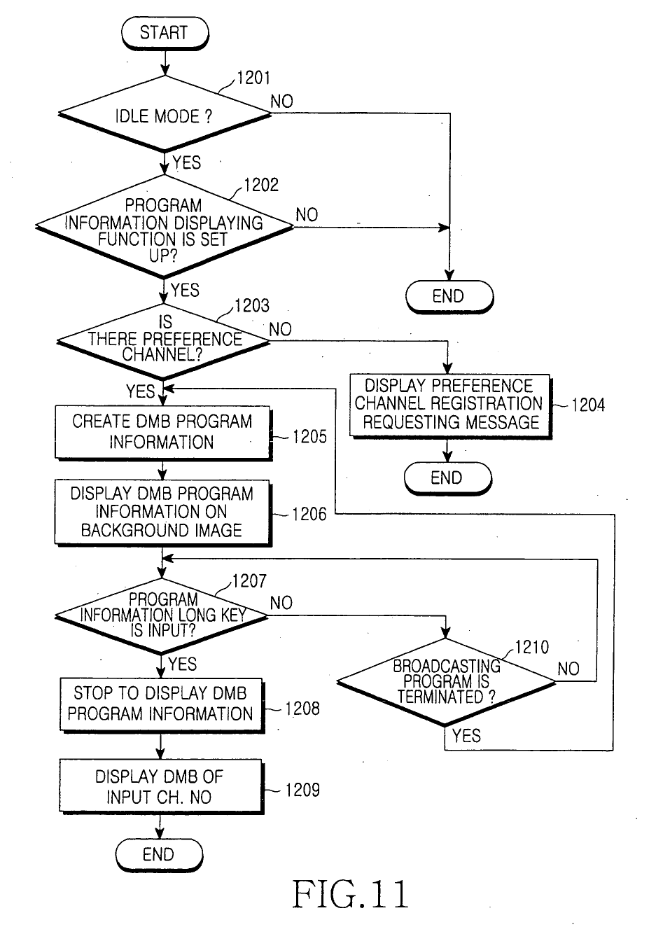

FIG. 11 is a flowchart illustrating a method of displaying DMB program information on a background image in an idle mode according to the present invention.

If the multimedia module 120 detects an idle mode in step 1201, the multimedia module 120 determines if a program information displaying function has been set up in step 1202. If a program information displaying function has been set up, the multimedia module 120 determines if preference channels have been registered in step 1203. If the preference channels have been registered, the multimedia module 120 creates DMB program information based on EPG information stored in the second memory 125 in step 1205. For example, if a user has registered four preference channels, four pieces of DMB program information are created. In contrast, if the multimedia module 120 determines that preference channels have not been registered, the multimedia module 120 controls a preference channel registration requesting message to be displayed on a background image in step 1204. According to the present invention, although steps 1203 and 1204 are included under the premise of preference channel registration, it is natural that the method be performed with respect to all channels. In this case, steps 1203 and 1204 are not required.

The multimedia module 120 controls the created program information to be displayed on the background image in step 1206, and the user can select a desired channel through the displayed DMB program information. A long key may be used for the selection of the desired channel.

The multimedia module 120 determines if the long key for a channel number is input in step 1207. If the multimedia module 120 detects the input of the long key for a channel number, the multimedia module 120 stops to display the DMB program information in step 1208. The multimedia module 120 performs a control operation in such a manner that a broadcasting program corresponding to the input channel number is displayed in step 1209. In other words, the DMB module 120 is controlled to receive a broadcasting program corresponding to the input channel number, and the second display unit 123 is controlled to display the broadcasting program.

If the input of the long key for the channel number is not detected in step 1207, the multimedia module 120 determines if it is time to terminate the broadcasting program corresponding to the program information which is currently displayed in step 1210. If it is not time to terminate the broadcasting program, the multimedia module 120 returns to step 1207. If it is time to terminate the broadcasting program (i.e., the time slot for a given program has ended), the multimedia module 120 returns to step 1205 in order to create DMB program information to be newly displayed by searching for EPG information about a next broadcasting program from the second memory unit 125. In other words, if it is time to terminate a broadcasting program of a certain preference channel, program information about a next broadcasting program is created. Although broadcasting programs of all preference channels are not terminated at the same time except for a special case, it is sufficient to create program information about next broadcasting information of all preference channels if the broadcasting programs of all preference channels are terminated at the same time.

For example, the multimedia module may be realized in such a manner that, when program information of a certain broadcasting program is displayed on a background image in the idle mode (e.g., step 1206), the multimedia module recognizes time of terminating the broadcasting program, drives a timer by comparing the time of terminating the broadcasting program with a current time, and then accesses the second memory 125 if the timer is terminated.

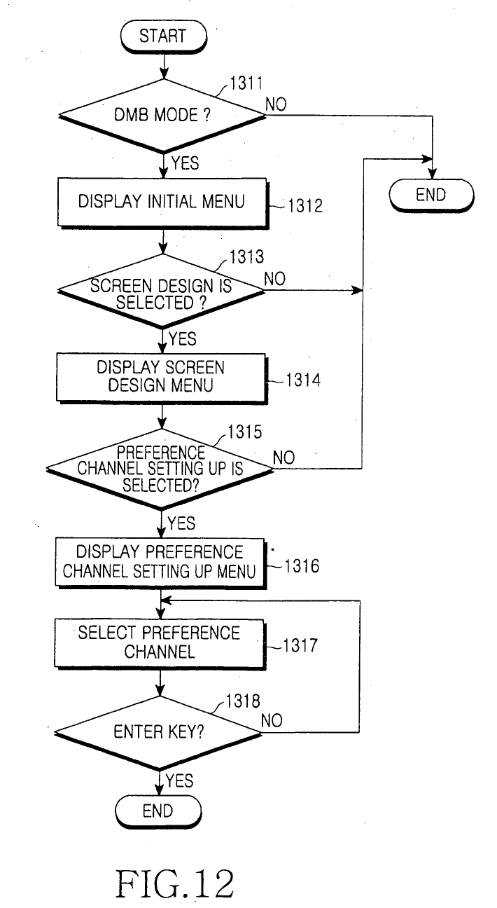

FIG. 12 is a flowchart illustrating a method of registering preference channels in order to display DMB program information on a background image in an idle mode according to the present invention.

The multimedia module 120 determines if a current terminal has a DMB mode in step 1311. If it is determined that the current terminal has a DMB mode, the multimedia module 120 performs a control operation such that an initial menu is displayed on the second display unit 123 in step 1312. If a user having recognized the initial menu selects an item of “screen design”, the multimedia module 120 detects the selection of the item in step 1313 and displays a screen design menu (e.g., reference numeral M1 shown in FIG. 7) in step 1314. If the user having recognized the screen design menu selects an item of “preference channel setting up”, the multimedia module 120 detects the selection of the item in step 1315 and displays a preference channel setting up menu (e.g., see, FIG. 7) in step 1316. Steps 1317 and 1318 are used for allowing the user having recognized the preference channel setting up menu to select at least one preference channel. The multimedia module 120 detects and stores a preference channel selected by the user through the key input unit 113 in step 1317 and determines if an “Enter” key is input in step 1318. In this case, if the input of the “Enter key” is detected, the multimedia module 120 recognizes the input of the “Enter key” as the termination of the preference channel selection and terminates the operation of registering preference channels. In contrast, if the input of the “Enter key” is not detected, the multimedia module 120 determines that there are further selections for other preference channels, so the procedure returns to step 1317.

Although not shown in detail, the second memory 125 may be realized using nano-flash memories and SDRAMs. The received EPG information is stored in the nano-flash memories and is copied into the SDRAMs when an operation relating to the EPG information is performed (e.g., program information is created).

As shown in FIG. 3, when the phone module 110 and the multimedia module 120 have the first display unit 112 and the second display unit 123, respectively, the multimedia module 120 transfers EPG program information to the phone module 110 by using dual port RAMs (DPRAMS) or arm internal memories (AIMs) (not shown) such that the program information can be displayed through the first display unit 112 controlled by the phone module 110.

Although the creation of DMB program information relates to overall channels in step 616 of FIG. 4, since the multimedia module 120 may create only corresponding DMB program information by reading out only EPG information corresponding to registered channels from the second memory unit 125 when preference channels are previously registered in a preference channel storing area of the mobile communication terminal as shown in FIG. 13. Accordingly, DMB program information which does not correspond with channels selected by the user is not displayed. Accordingly, power is conserved, and user satisfaction is improved.

As described above, the mobile communication terminal may be constructed using only one display unit or as one body, or may have another type instead of a folder type. In this case, it is well known to those skilled in the art that a folder state determining step of step 618 or the step of selecting a display unit for displaying the DMB program information is unnecessary.

In addition, mobile communication terminals may be constructed in such a manner that their control units control MP3 player functions, digital video disc player functions, or telematics functions according to types of the mobile communication terminals.

As described above, according to the present invention, when a user requests information corresponding to currently broadcast programs on selected channels, the requested information is displayed in an idle mode instead of a DMB mode, thus increasing convenience and preventing unnecessary power consumption (a DMB module is driven in the DMB mode).

While the invention has been shown and described with reference to certain preferred embodiments thereof, it will be understood by those skilled in the art that various changes in form and details may be made therein without departing from the spirit and scope of the invention. Consequently, the scope of the invention should not be limited to the embodiments discussed herein, but should be defined by the appended claims and equivalents thereof.

What is claimed is:

1. An apparatus for displaying digital broadcasting program information in a terminal capable of receiving digital broadcasting, the apparatus comprising:
a digital broadcasting receiving unit for receiving broadcasting channel guide information;
a memory for storing received broadcasting channel guide information;
a control unit for creating program information based on the broadcasting program guide information; and
a display unit for displaying the program information on a background image.

2. The apparatus as claimed in claim 1, wherein the control unit periodically determines whether a terminating time of a current broadcasting program has arrived, and creates program information corresponding to a new program in real time based on the stored broadcasting channel guide information when it is determined that the termination time has arrived, and controls such that the program information is displayed on the background image.

3. The apparatus as claimed in claim 1, wherein the control unit scrolls the program information displayed on the background image in a predetermined direction.

4. The apparatus as claimed in claim 1, wherein at least one piece of program information is displayed on an entire area or a partial area of the background image.

5. The apparatus as claimed in claim 3, wherein the predetermined direction corresponds to one of a left and right direction or one of an up and down direction.

6. The apparatus as claimed in claim 4, wherein at least one piece of program information corresponds to at least one piece of program information of a preference channel registered by a user in advance.

7. The apparatus as claimed in claim 6, wherein the control unit determines whether a predetermined period, counted by a counter, corresponding to a current broadcasting program has elapsed, and creates program information corresponding to a new program in real time based on the stored broadcasting channel guide information if it is determined that the predetermined period has elapses and controls such that the program information corresponding to the new program is displayed on the background image.

8. The apparatus as claimed in claim 1, wherein the program information is displayed on a text slide area of the background image mode.

9. The apparatus as claimed in claim 8, wherein the program information is displayed in an idle mode.

10. The apparatus as claimed in claim 1, wherein the control unit includes a phone module and a multimedia module, and the phone module controls the program information received from the multimedia module to be displayed on a text slide area of an image of the display unit.

11. The apparatus as claimed in claim 1, wherein the control unit controls an MP3 (MPEG-1 Audio Layer-3) player function.

12. The apparatus as claimed in claim 1, wherein the control unit controls a digital video-disc player function.

13. The apparatus as claimed in claim 1, wherein the control unit controls a telematics function.

14. The apparatus as claimed in claim 1, wherein the display unit includes a first display unit for displaying information regarding a portable telephone function of the terminal and a second display unit for displaying a digital broadcasting program.

15. The apparatus as claimed in claim 14, wherein the control unit detects a folder state and controls the program information to be displayed on the second display unit when the folder is opened.

16. The apparatus as claimed in claim 14, wherein the control unit controls the program information to be displayed on an image of the first display unit when the folder is closed.

17. A method for displaying digital broadcasting channel information in a mobile communication terminal including a display unit and a digital broadcasting receiving unit, the method comprising the steps of:
storing received broadcasting program guide information in a memory;
creating program information based on the stored broadcasting channel guide information; and displaying the created program information on a background image of the display unit.

18. The method as claimed in claim 17, further comprising displaying the program information, driving the digital broadcasting receiving unit if selection of a channel number by a user is detected, and receiving a digital broadcasting program corresponding to the selected channel number.

19. The method as claimed in claim 17, further comprising determining if a time of terminating a current broadcasting program has arrived; and
creating program information corresponding to a newly starting program in real time based on the stored broadcasting channel guide information such that the program information is displayed on the background image, if the terminating time has arrived.

20. The method as claimed in claim 17, further comprising registering at least one preference channel in a digital multimedia broadcasting mode, wherein at least one piece of program information displayed on a background image when the terminal has the idle mode corresponds to program information created based on the broadcasting channel guide information corresponding to the registered preference channel.

21. The method as claimed in claim 17, further comprising displaying the program information by scrolling the program information with a predetermined period in a predetermined direction.

22. The method as claimed in claim 17, wherein, the step of displaying the created program information, the program information is displayed on the background image in an idle mode.

23. The method as claimed in claim 17, wherein, in the step of displaying the created program information, the program information is displayed on a text slide area of the background image.

24. The method as claimed in claim 23, wherein the program information is created based on a predetermined criterion.

25. The method as claimed in claim 24, wherein the predetermined criterion is set by the user.

26. A method for displaying digital broadcasting program information in a terminal capable of receiving digital broadcasting, the terminal including a first module for controlling a first function, a first display unit for performing display according to the first function, a second module for controlling a multimedia function, and a second display unit for performing display according to the multimedia function, the method comprising the steps of:
determining by the second module if a program information displaying function is set;
if the a program information displaying function is set, creating program information based on the broadcasting channel guide information by the second module;
detecting a folder state by the second module;
if it is detected that the folder is opened, displaying by the second module the created program information on a text slide area of a background image of the second display unit;
if it is detected that the folder is closed, transmitting by the second module the created program information to the first module; and
receiving the program information and displaying the program information on a text slide area of a background image in the first display unit by the first module.

27. The method as claimed in claim 26, wherein the second module determines if a broadcasting slide function is set in an idle mode.

28. The method as claimed in claim 26, further comprising:
if the first module detects that a channel number is input by a user after the program information is displayed on the text slide area of the background image in the first display unit, displaying a folder open request message on the text slide area of the background image in the first display unit; and
if the first module detects that the folder is opened after the folder open request message is displayed, requesting digital broadcasting corresponding to the input channel number to the second module.

29. The method as claimed in claim 26, wherein the first module includes a phone module for controlling a portable telephone function.

30. The method as claimed in claim 28, wherein the first module includes a phone module for controlling a portable telephone function.

31. The method as claimed in claim 26, further comprising stopping display of the second display unit for the program information, and displaying the digital broadcasting corresponding to the input channel number on the second display unit if the second module detects that the user has input a channel number after the program information is displayed on the text slide area of the background image in the second display unit.

32. A method for displaying digital broadcasting program information in a mobile communication terminal including a display unit and a digital broadcasting receiving unit, the method comprising the steps of:
receiving digital broadcasting program guide information and storing the digital broadcasting program guide information in a memory;
detecting electronic program guide information stored in the memory and creating program information satisfying a predetermined criterion; and
displaying the created program information on a background image of the display unit.

33. The method as claimed in claim 32, wherein the step of displaying the created program information, the program information is displayed on the background image in an idle mode.

34. The method as claimed in claim 32, further comprising:
driving the digital broadcasting receiving unit if it is detected that a user selects a program number after the program information is displayed; and
receiving digital broadcasting program corresponding to a selected channel number and providing the digital broadcasting program to the display unit by the digital broadcasting receiving unit.

35. The method as claimed in claim 32, further comprising determining whether a program information displaying function is set when the mobile communication terminal is in an idle mode.

36. The method as claimed in claim 32, wherein the predetermined criterion is set by a user and includes time and channels.

37. The method as claimed in claim 32, further comprising the steps of determining if time of terminating a current broadcasting program has arrived; and
creating program information corresponding to a newly starting program in real time based on the stored broadcasting channel guide information such that the program information is displayed on the background image, if the terminating time has arrived.

38. The method as claimed in claim 32, further comprising registering at least one preference channel in a digital multimedia broadcasting mode, wherein at least one piece of program information displayed on a background image when the terminal is in an idle mode corresponds to the program information created based on broadcasting channel guide information corresponding to the registered preference channel.

39. The method as claimed in claim 32, further comprising displaying the program information by scrolling the program information with a predetermined period in a predetermined direction.

40. A terminal comprising:
a digital broadcasting module for controlling an operation of receiving digital broadcasting;
a first module for controlling a first function;
a first display unit for displaying program information regarding the digital broadcasting on a text slide area of a background image or displaying according to the first function;
a second module for controlling a second function; and
a second display unit for displaying according to the second function, displaying a digital broadcasting program, or displaying the digital broadcasting program information on a text slide area of a background image.

41. The terminal as claimed in claim 40, wherein the first function includes a portable telephone function, and the second function includes a personal portable terminal function.

42. The terminal as claimed in claim 40, wherein the digital broadcasting includes digital multimedia broadcasting.
